(19) United States
(12) Patent Application Publication
(10) Pub. No.: US 2006/0160448 A1
(43) Pub. Date: Jul. 20, 2006

(54) Antimicrobial fabric and method for maunfacture of antimicrobial fabric

(75) Inventors: George Abraham, Mosman NSW (AU); Ian H. Disley, Lindley (GB); Samir Nassif, Wiley Park (AU)

Correspondence Address: BANNER & WITCOFF, LTD., TEN SOUTH WACKER DRIVE, SUITE 3000, CHICAGO, IL, 60606, US

(73) Assignee: Advanced Fabrics (SAAF), Al-Ahsa (SA)

(21) Appl. No.: 11/248,312

(22) Filed: Oct. 12, 2005

Related U.S. Application Data
(60) Provisional application No. 60/619,519, filed on Oct. 15, 2004.

(51) Int. Cl. B32B 27/12; B32B 27/04; B32B 5/26; D04H 1/54; D04H 3/16

(52) U.S. Cl. 442/121; 442/401; 442/400; 442/123; 442/382; 442/394; 442/409; 264/211; 264/103; 264/555; 264/171.1; 156/62.4

(57) ABSTRACT

Antimicrobial fibers useful for the manufacture of gas permeable fabrics are manufactured by co-extrusion of polymerics and antimicrobial materials. The fibers may be ed in various combinations to provide antimicrobial fabric materials.

### CROSS REFERENCE TO RELATED APPLICATION

This is a utility application based upon, incorporating by reference and claiming priority to Ser. No. 60/619,519 filed Oct. 15, 2004, entitled “Antimicrobial Fabric and Method for Manufacture of Antimicrobial Fabric”.

### FIELD OF THE INVENTION

Briefly, the present invention relates to non-woven fabrics, which possess antimicrobial characteristics, and a process for manufacture of such fabrics.

### BACKGROUND OF THE INVENTION

Personal protection from contamination and/or infectious materials has become an increasingly important concern for people in all aspects of life. Contamination can originate from a variety of sources: airborne; carried by fluids; solids and/or particulates. However, just as important as personal protection, is personal comfort.

A variety of materials and products have traditionally been used to provide barrier properties to single-use fabrics, including, but not limited to, nonwovens from a variety of processes, films, and combinations and/or laminates thereof. These materials have been found to be effective in a multitude of uses, including articles of clothing, protective apparel, health-care-related materials (such as gowns, surgical drapes, sterile wraps, diapers, training pants, incontinence products, feminine care products, wipes, beddings, pads, and the like).

While films have traditionally been used to provide barrier properties in single-use products, they have been found to exhibit certain disadvantages. These films are excellent in the prevention of the exchange of microorganisms between the wearer and the patient, and the reverse. They are usually one to two mils in thickness, have a basis weight of approximately 0.7 to 1.5 ounces per square yard, and are most commonly produced from polyolefins, usually polypropylene or polyethylene. While providing an excellent barrier, such films also provide the minimum in comfort. Garments or personal use products made from or containing films tend to be hot, as they do not permit the passage of water vapor generated by the wearer in the form of perspiration. As a result, the water vapor is retained inside the garment, creating a humid, clammy, sticky environment inside the garment, rapidly leading to a lack of comfort.

In response to this circumstance, scientists developed fabrics that provide a certain amount of breatheability, while maintaining certain characteristics as a barrier. These fabrics come in many constructions, notably fabrics manufactured as nonwovens, and most notably fabrics manufactured from the spunbond and meltblown processes, as laminates thereof. While providing significant improvements in comfort, there was identified as a limitation, their ability to provide adequate protection in the form of barrier properties, especially for smaller microorganisms and contaminants.

In recent years there have been advancements in the manufacture of fabrics that utilize films that breathe, that is to say they allow the passage of water vapor. Through this capability, garments and personal use fabrics that utilize these “breathable” films have offered improvements in their ability to provide the wearer an increase in the barrier properties over non-film containing materials. These materials do exhibit the ability to breath, albeit at a reduced level.

However, there continue to be identified limitations in the barrier properties of nonwoven and/or laminates that utilize microporous films. The primary concern results from the fact that no matter how small the pore size, there is the potential for microorganisms, whether they be viruses or bacteria, that are smaller than the pore size, thus allowing transmission. Nonetheless, certain applications require an absolute barrier for microorganisms while providing the wearer with comfort. For this reason, and for these applications, nonwoven fabrics, microporous films, and/or laminates of these materials are not suitable.

There have also been disclosed fabrics with improved barrier properties through the use of post-manufacture treatments. These post manufacture treatments apply a chemical through several means directly to the surface of the fabric after manufacture. Some of these post manufacture systems can be in-line with the fabric manufacturing process, or can be off-line. If in-line, the chemical application process occurs after the manufacture of the fabric, but prior to the wind-up process. If off-line, the fabric is manufactured and wound, and then subsequently unwound, treated, and rewound.

Each process has potential advantages over the other, many of which are based on the philosophies of the specific manufacturer. However, both processes have the same disadvantages. Both require additional processes of chemical addition systems, most of which utilize liquid application systems. Liquid application systems, by nature, provide many challenges in maintenance and housekeeping, both in the system itself and in maintaining the surrounding areas. Due to the ever present potential for chemical spills, the preparation and mixing of chemicals typically requires an area that is separated from the manufacturing area. In the application area itself, there is always the potential for overflowing treatment, excess treatment passing from the treated fabric onto downstream equipment, resulting in contamination. Housekeeping is always an issue, as regular cleaning is required to maintain the treatment equipment and other, nearby equipment, cleanly.

In addition, liquid treatment systems generally cause the development of airborne particulates, which derive from the treated fabric after treatment, and before drying. These airborne particles will, over time, enter the air system of the manufacturing facility potentially contaminating non-related components such as motors, fans, electrical cabinets, and the like.

Most liquid application systems utilize water as the carrier for the chemicals to be applied. In this regard, as these chemicals are dispersible in water, they can also be easily removed by water or other liquids. In many applications where these fabrics are used, a variety of liquids is present. If the fabric is contacted with the liquid during use, there is a distinct possibility that the applied chemicals will be solubilized and removed, rendering the fabric ineffective.

Also, with the incorporation of liquid-based application systems comes the additional requirement of drying. In addition to the increased capital outlay, dryers have negative impacts on several levels. First, fabrics that are exposed to a dryer, typically experience a loss in the physical properties of tensile strength, elongation, tear resistance, as well as tactile properties of drape, feel, and softness. Second, the fumes generated by the removal of the liquid on the fabric will carry a certain amount of the chemicals. These fumes are typically not desired to be kept inside the manufacturing facility and are, therefore, exhausted into the environment which may result in adverse consequences.

Therefore, there still exists the need for a low cost, simple, hygienic, environmentally friendly fabric and method to manufacture a fabric that can be made into garments, or personal use products, that provides a barrier to microorganisms such as viruses and bacteria, both large and small, while still allowing the passage of water vapor, thereby providing a level of comfort to the wearer.

### SUMMARY OF THE INVENTION

The present invention comprises incorporation of an antimicrobial agent into the melt of a polymer prior to formation into continuous filaments and/or microfibers, where said continuous filaments and/or microfibers are formed as a part of a process that includes the extrusion, drawing, quenching, and deposition of said continuous filaments and/or microfibers onto a formiferous belt, said belt used to transport said continuous filaments and/or microfibers to a bonding process, where said continuous filaments and/or microfibers form an initial fabric. This initial fabric is subsequently wound and may be used to form a nonwoven fabric that has antimicrobial properties. The antimicrobial agent can also be incorporated into a polymer in the molten state prior to the manufacture of a film, where the resulting film would have antimicrobial properties. The fabrics manufactured from these materials can be single layer, multi-layered, composites and/or laminates of fabrics comprised entirely of continuous filaments, microfibers, films, or any combination thereof. Various combinations and/or laminates of said initial fabric would form one or more layers in the final fabric. Combinations of the various fabrics can be accomplished in a number of ways, including in-line production, on-line production, or off-line production, where said fabrics form layers that are joined through various processes.

Uses for this antimicrobial fabric include baby diapers, training pants, adult incontinence products, health care related garments, drapes, and wraps, and protective apparel such as coveralls and face masks, wipes, and filtration.

The incorporation of the antimicrobial agent into the polymer prior to extrusion into a fiber causes the antimicrobial agent to be held inside the resulting filaments, fibers, and/or films. The antimicrobial agent typically exhibits a capability to move or migrate throughout the individual extruded fibrous or film structures, eventually making its way to the surface of the individual structures. For this reason, among others, the resulting fabrics exhibit durability and longevity of the antimicrobial properties.

While there are many and varied types of nonwovens, with many processes and methods of manufacture, of particular interest are the nonwovens made from the spunbond and meltblown processes. In addition, of particular interest are fabrics that are made or derived from laminates of spunbond and meltblown fabrics including fabrics that are generated from spunbond fabrics laminated with a microporous film, spunbond and meltblown laminates that are laminated with a microporous film, and any variations thereof.

Thus, it is an object of this invention to provide a fabric that provides a barrier to viruses and bacteria, both large and small, while at the same time allowing for the passage of water vapor.

It is a further object of this invention to provide a fabric that provides a barrier to viruses and bacteria, both large and small, while at the same time allowing for the passage of water vapor, where the fabric is manufactured without the secondary processes for the application of a surface treatment and subsequent drying.

It is a further object of this invention to provide a fabric that provides a barrier to viruses and bacteria, both large and small, while at the same time allowing for the passage of water vapor, where the fabric is manufactured with an antimicrobial agent incorporated internally to the material, in one or more layers of the final product.

It is a further object of this invention where the fabric to be used exhibits durable, or permanent antimicrobial properties, where the antimicrobial agent can be removed neither through mechanical rubbing, nor contact with liquids, nor contact with vapors.

It is a further object of this invention where the fabric to be used is manufactured from a nonwoven, spunbond material.

It is a further object of this invention where the fabric to be used is manufactured from a nonwoven, meltblown material.

It is a further object of this invention where the fabric to be used is manufactured from a microporous film.

It is a further object of this invention where the fabric to be used is manufactured from a material that is a laminate of any of a spunbond nonwoven, a meltblown nonwoven, and/or a microporous film, where any one or all layers could have an internally-added antimicrobial agent.

It is a further object of this invention where the fabric containing the durable antimicrobial agent is converted into hygienic products such as diapers, training pants, adult incontinent products, feminine napkins, bed pads, and the like.

It is a further object of this invention where the fabric containing the durable antimicrobial agent is converted into medical fabrics such as surgical gowns, patient drapes, sterile wraps, and the like.

It is a further object of this invention where the fabric containing the durable antimicrobial agent is converted into protective apparel such as jackets, outerwear, coveralls, face masks, and the like.

It is a further object of this invention where the fabric containing the durable antimicrobial agent is converted into baby wipes, industrial wipes, household wipes, and the like.

It is a further object of this invention where the fabric containing the durable antimicrobial agent is converted into filters to be used in liquid filtration, air filtration, and the like.

It is a further object of this invention where the fabric containing the durable antimicrobial agent is converted into industrial fabrics such as furniture and bedding fabrics, pillow covers, head rest covers, and the like.

These and other objects of the present invention will be set forth hereinafter. Examples of the present invention are being given only be way of illustration and are not to be considered as limitations of said invention. Various changes and modifications to these examples will be well within the scope of the invention.

### BRIEF DESCRIPTION OF THE DRAWING

In the detailed description which follows, reference will be made to the drawing comprised of the following figures and/or photographs:

FIG. 1 is a diagrammatic view of a process for manufacture of the fabric of the invention and more particularly the fibers utilized in the manufacture of the fabric of the invention;

FIG. 2 is a diagrammatic view of a second embodiment useful for the manufacture of fibers used for making fabric as contemplated by the invention;

FIG. 3 is a diagrammatic view of a further embodiment for the manufacture of fibers in accord with the invention;

FIG. 4 is a diagrammatic view illustrating yet another method for manufacture of fibers in accord with the invention;

FIG. 5 is a diagrammatic or schematic view of spun bond polypropylene single layered fabric;

FIG. 6 is a diagrammatic or schematic view of spun bond polypropylene two layered fabric;

FIG. 7 is a diagrammatic or schematic view of three plus layered fabrics of spun bond polypropylene;

FIG. 8 is a diagrammatic or schematic view of melt blown polypropylene single layer fabric;

FIG. 9 is a diagrammatic view of melt blown polypropylene two layered fabric;

FIG. 10 is a multiple layer melt blown polypropylene fabric depicted in a diagrammatic view;

FIG. 11 is a diagrammatic view of a combined spun bond and melt blown composite fabric;

FIG. 12 is a diagrammatic view of a further embodiment of mixed spun bond and melt blown composite fabric;

FIG. 13 is a diagrammatic view of a further embodiment of a composite spun bond and melt blown fabric;

FIG. 14 is a diagrammatic view of another composite fabric of spun bond melt blown and film material; and

FIG. 15 is a photograph of a spunbond fabric incorporating an antimicrobial agent added to a polymeric melt material.

### DESCRIPTION OF THE PREFERRED EMBODIMENTS

The product of the invention generally comprises an antimicrobial and/or antipathogenic fiber or fiber composite which may be fabricated into any of a number of fabric type materials characterized by their breatheability and antipathogenic benefits. Further, the fiber or fibrous materials may be manufactured by methods which result in combining antipathogenic materials within as well as on the fibrous materials. Methods for combining such fibrous materials into fabrics and laminates are also disclosed.

The thermoplastic or polymeric composition for the manufacture of fibrous materials of the present invention can be prepared by any number of methods. For example, a polymer in chip or pellet form and an additive such as an antimicrobial additive material in powder, or liquid form, can be mixed mechanically to coat the polymer particles with the additive. While the additive can be dissolved in a proper solvent to aid the coating process, the use of a solvent is not desired or necessary. The coated polymer then can be added to the feed hopper of an extruder, which is connected to a die, from which extruded fibers will emerge. Alternatively, the coated polymer can be fed into a compounding or mixing device, such as a heated single screw extrusion device, a twin-screw compounding device, or other such thermal mixing apparatus, in order to generally uniformly disperse the additive throughout the polymeric blend or matrix. The resulting thermoplastic composition typically is extruded as narrow plastic cylinders which are cooled and then fed to a cutting or chipping device. The chips then serve as the feed stock for a melt-processing extruder. In another method, the additive, in powder, pellet, or liquid form, can be fed into the feed throat of the hopper of an extruder, in a controlled manner, so that it blends with the primary polymeric material in particulate form, which enters the feed zone of an extruder, where the two materials are then blended together. In yet another method, the additive can be metered directly into the barrel of an extruder where it is blended with the polymer that is already in a molten state, as the resulting mixture moves toward the die, from which fibers will emerge. While the antimicrobial additive may be in powder, pellet, or liquid form, the pellet form is considered a preferred form.

The resulting fibers, having antimicrobial or antipathogenic properties, are readily prepared by melt-extruding a melt-extrudable thermoplastic composition through multiple orifices to form streams of a molten composition which are cooled to form fibers. The melt-extrudable thermoplastic composition includes at least one thermoplastic material and at least one additive which includes an antimicrobial or antipathogenic material, which additive is dispersed generally uniformly, in preferred embodiments, throughout the interior as well as on the surface of the molten composition which subsequently solidifies to impart antimicrobial properties to the surfaces of the fibers. The resulting fibers may have a mean diameter in the range of 16.7 to 18.0 microns with the average of 17.6 microns.

The method of the present invention for preparing a nonwoven web having antimicrobial properties involves melting a melt-extrudable, thermoplastic composition, extruding the molten composition through multiple orifices to form streams of molten composition which are cooled to form fibers which then are randomly deposited on a moving conveying surface, typically having a certain permeability to air flow, to form a web, wherein the melt-extrudable thermoplastic composition includes at least one thermoplastic material and at least one additive which includes an antimicrobial material, which additive is dispersed within the interior as well as on the surface of the molten composition so as to impart antimicrobial properties when the melt-extrudable thermoplastic composition is extruded into, for example, fibers.

The term “melt-extrudable material” is used to include any material that can be altered so that its shape can be changed into a product by melting or by melt extrusion. Therefore, while the term would include both thermosetting and thermoplastic materials, of particular uses are the thermoplastic materials, and more specifically the thermoplastic polyolefin materials.

In general, the term “thermoplastic polyolefin material” is used to describe any thermoplastic polyolefin which can be used for the preparation or shaping of articles by melting or by melt extrusion, for example, fibers and nonwoven webs. Examples of thermoplastic polyolefins include polyethylene, polypropylene, poly(1-butene), poly(2-butene), poly(1-pentene), poly(2pentene), poly(3-methyl-1-pentene), poly(4-methyl-l-pentene), 1,2-poly-1,3-butadiene, 1,4poly-1,3-butadiene, polyisoprene, polychloroprene, poly(vinyl acetate), poly(vinylidene chloride), polystyrene, and the like. Furthermore, the term “thermoplastic polyolefin material” is also meant to include blends of two or more polyolefins, as well as random and block copolymers prepared from two or more different unsaturated monomers. The most significant polyolefins are polyethylene and polypropylene.

The term “antimicrobial” is to be broadly interpreted and may include antipathogenic materials and other materials designated or fashioned to terminate or inhibit viability of microbial materials, viruses, bacteria and other materials considered undesirable or a hazard to health or well being. An exemplary antimicrobial may be triclosan, a derivative of diphanyl ether supplied by Ciba Specialty Chemicals.

A preferred embodiment of the present invention is in the manufacture of fibrous webs, whereby said fibrous webs are classified as either spunbond webs, meltblown webs, or combinations, utilizing polypropylene polymeric materials, wherein the spunbond and meltblown webs can be utilized as single webs to produce mono-layered materials, or in combinations to produce multi-layered laminates. In the methods where spunbond webs are utilized, either in mono or multi-layered materials, it is preferred to utilize thermal bonding techniques to join the fibers together in the manufacture of a fabric substrate. In the methods where meltblown webs are used without spunbond fibers, thermal bonding is not necessary, but might be used to impart a pattern or to provide additional physical properties.

In the method of manufacture where multiple layers of fibrous webs are utilized in the manufacture of a final fabric, the antimicrobial material may be utilized in all, or some, or only one of the individual fibrous layers, and still provide effectiveness in combination as an antimicrobial fabric. However, it is preferred that in the event of multiple fibrous layers, the antimicrobial material is incorporated into those layers that are intended to form the outer layers of the fabric. In this regard, the antimicrobial material is most likely to have the greatest effect, as it will be in direct contact with the microbial or microbial carrying substrate.

Further, however, an intermediate antimicrobial layer may tend to entrap undesirable materials capturing them to prevent spreading thereof.

The present invention is further described by the following examples. Such examples, however, are not to be construed as limiting in any way the scope of the present invention.

### EXAMPLE 1

In the diagram for FIG. 1, which depicts a preferred embodiment, a polymeric material 10, typically in pellet form, is blended together in a blending mechanism 14 with the antimicrobial-containing additive 12, so that the polymeric material is coated with the antimicrobial-containing material. The antimicrobial-containing material can be in powder or liquid form. The blending process can be any number of processes, and is not generally considered as a limitation to the invention. Importantly, the polymeric material and the antimicrobial-containing additive are joined together so that there is a blend 15 that is then introduced to an extruder 16, which is connected to a die 18, from which fibers 20 will emerge. The fibers 20, typically in solid form, may then be processed as described hereinafter.

### EXAMPLE 2

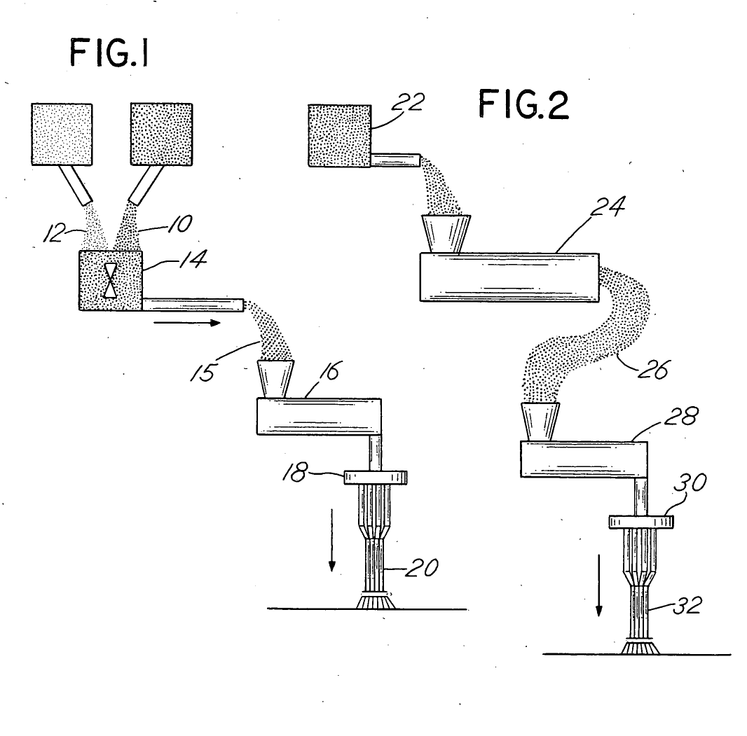

In the diagram of FIG. 2, the polymeric material 22, typically in pellet form, is blended together with the antimicrobial-containing additive, so that the polymeric material is coated with the antimicrobial-containing material. The antimicrobial-containing material can be in powder or liquid form. The blending process can be any number of processes known and is not generally a limitation to the invention. The polymeric material and the antimicrobial-containing additive are joined together so that there is a blend that is then introduced to a compounding process or machine 24. This process is utilized where enhanced uniformity of the dispersion of the antimicrobial-containing material is desired. This is also useful where large quantities are to be utilized, or large-scale manufacturing is desired whereby reduced variability between non-consecutive production runs is foreseen. The resulting chips or pellets 26 are then fed to an extruder 28, which is connected to a die 30, from which fibers 32 will emerge.

### EXAMPLE 3

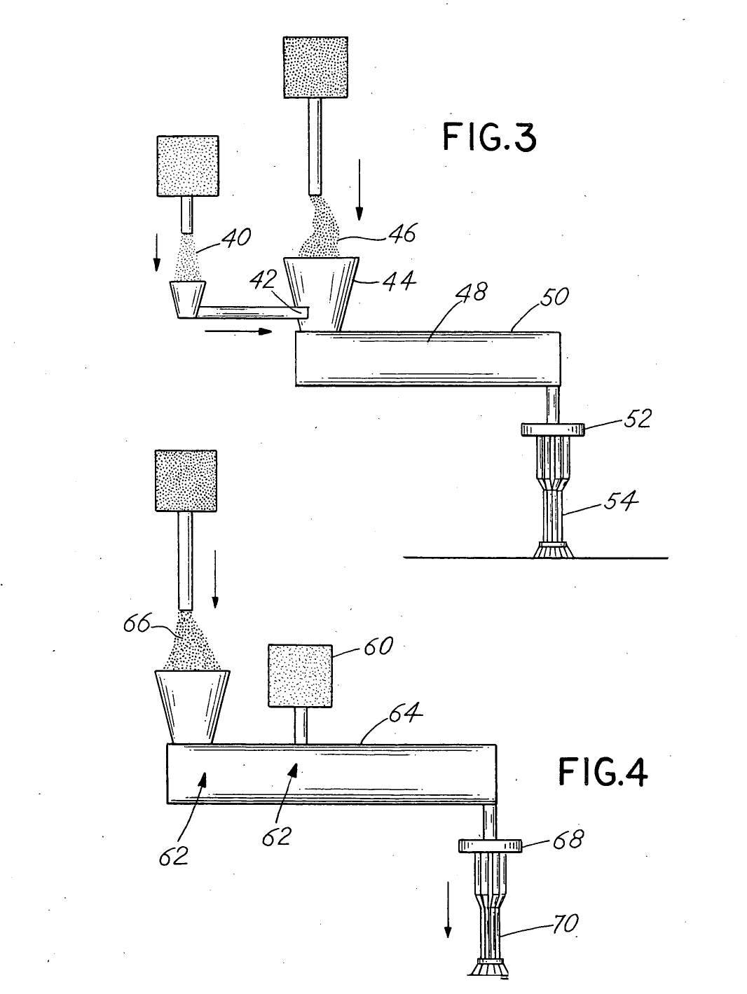

In the diagram of FIG. 3, the antimicrobial-containing additive 40, in powder, pellet, or liquid form, can be fed into the feed throat 42 of the hopper 44 of an extruder, in a controlled manner, so that it blends with the primary polymeric material 46 in particulate form, which enters the feed zone 48 of an extruder 50, where the two materials are then blended together. Once blended in the feed-portion of the extruder 50, the materials are then passed through the extruder 50, where they are combined into a molten-blend, as is the process in most extruders. The blend then passes into a die 52, from which fibers 54 will emerge.

### EXAMPLE 4

In the diagram of FIG. 4, the antimicrobial-containing additive 60, in powder, pellet, or liquid form, can be fed into the melt transition portion 62 of an extruder 64, in a controlled manner, so that it blends with the primary polymeric material 66 in molten form, which enters the melt transition portion 62 of an extruder 64, where the two materials are then blended together. This is most applicable where the antimicrobial-containing additive is in liquid form. Once blended in the melt transition portion 62 of the extruder, the materials are then passed through the extruder, where they are combined into a molten-blend, as is the process in most extruders. The blend then passes into a die 68, from which fibers 70 will emerge.

The percentage of the antimicrobial material can be anywhere from 0.01% up to 25% by weight, in any single layer, or multiple layers, in the case of fabrics that are made from multiple layers of fibrous materials. The percentage can be equivalent in every layer, or can be varied in the individual layers. Optimally the percentage will be from about 0.01% to about 10.0% by weight, and most optimally the percentage will be from about 0.01% to about 1.00% by weight.

The antimicrobial-containing additive can be blended combined with the polymeric material in a variety of ways, as mentioned previously. In order to produce the fibers of the fibrous mats, the polymeric material, with the antimicrobial additive now blended, passes through the melt transition stage whereby the blended material become molten. This process is necessary to develop a molten material of such viscosity so as to allow the production of fibers through the die. Processing, extrusion, and spinning temperatures are all dependent on the type of polymer, or polymers (in the case of multiple polymer blends), and the melt flow rate as known in the art of extrusion and fiber spinning. For these, there are no unusual processing temperatures or other processing settings that would be considered unusual or abnormal. The following examples are meant for demonstrative purposes only are not meant to limit the scope of the invention.

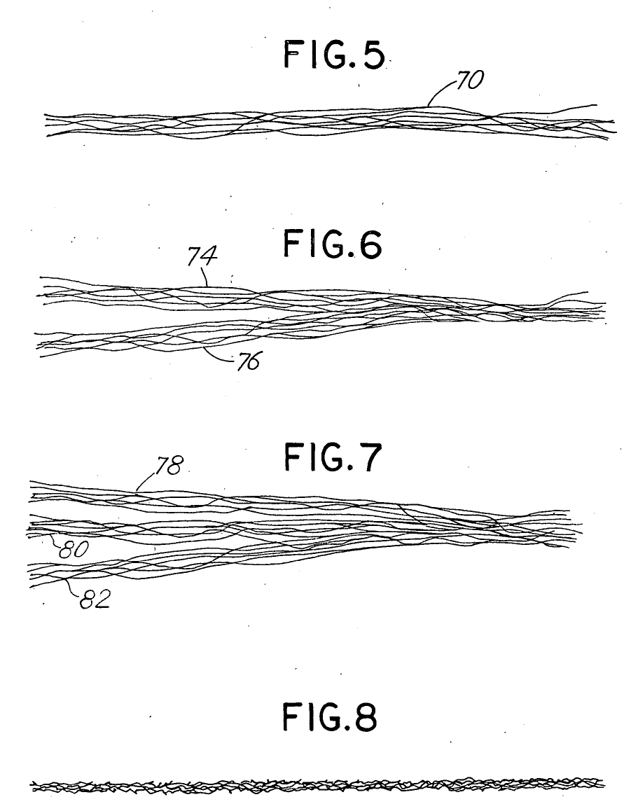

These examples depicted in FIGS. 5-14 are of various fabric structures where layers of fibrous webs of polypropylene, derived from an extrusion process as previously described, are laid down in single or multiple layered constructions to create fabrics of varying properties. The antimicrobial material can be incorporated in any one or all of the layers of the files and/or the fabrics, in the case of fabrics that are made from multiple layers of fibrous mats.

FIG. 5 illustrates a first embodiment wherein fibers 70 made from spunbond polypropylene are arrayed as a single layered fabric. The fibers include antimicrobial material fashioned in the manner previously described. The fibers are bonded together to form a single layered fabric.

FIG. 6 illustrates a two layered composite of spunbond polypropylene wherein the fibers comprise antimicrobial materials. Thus, a first layer 74 and a second layer 76 are bonded together to form a multi-layered fabric. Some or all of the fibers in each of the layers, or both of the layers, include antimicrobial characteristics created in the manner previously described. The two layer composite is identified as “S-S”. FIG. 7 illustrates spunbond polypropylene comprised of a first layer 78, a second layer 80 and a third layer 82 (S-S-S). The layers may each include antimicrobial material. Fibers in each of the layers may include antimicrobial material. For example, the middle layer 80 may not include antimicrobial material whereas the outer layers 78 and 82 will. The layers are bonded together to form a multilayered fabric.

FIG. 8 discloses a melt blown polypropylene single layered fabric with antimicrobial characteristics. The fiber can be bonded or unbonded.

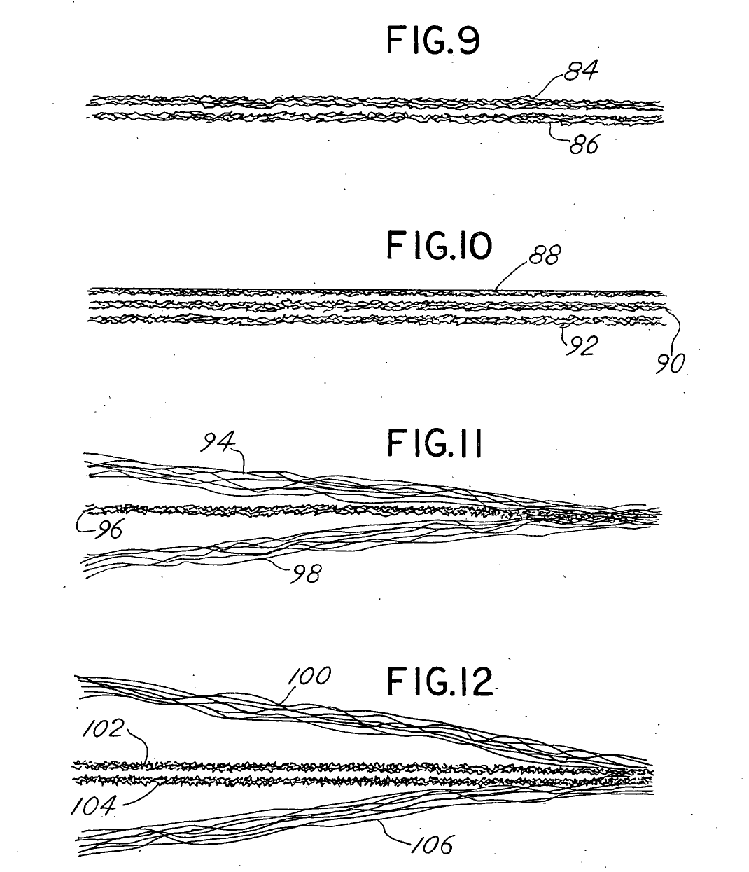

FIG. 9 illustrates a two layered composite of melt blown polypropylene (M-M) wherein each of the layers is antimicrobial and again the fabric can be bonded or unbonded. The layers 84 and 86 thus comprise the air permeable or gas permeable fabric material.

FIG. 10 discloses or depicts a three layered composite (M-M-M) wherein a first layer of melt blown polypropylene 88 is combined with a second layer 90 and a third layer 92. Any one or more of the layers may be with or without antimicrobial material and the fabric may be bonded or unbonded.

FIG. 11 is comprised of a mixture of spunbond and melt blown layers. A three layer composite (S-M-S) includes a first layer 94 which is spunbond middle layer which is melt blown and a third outer layer 98 which is spunbond. The layers are bonded together to form a multilayered fabric and one or more the layers may include the fibers derived and including an antimicrobial material.

FIG. 12 discloses a four layer composite identified as (S-M-M-S) wherein a first or outer layer 100 is spunbond and the two inner layers 102 and 104 are melt blown and a third or fourth outer layer 106 is spunbond. Any one or more of the layers may include antimicrobial material and the layers are bonded together to form a multilayer fabric.

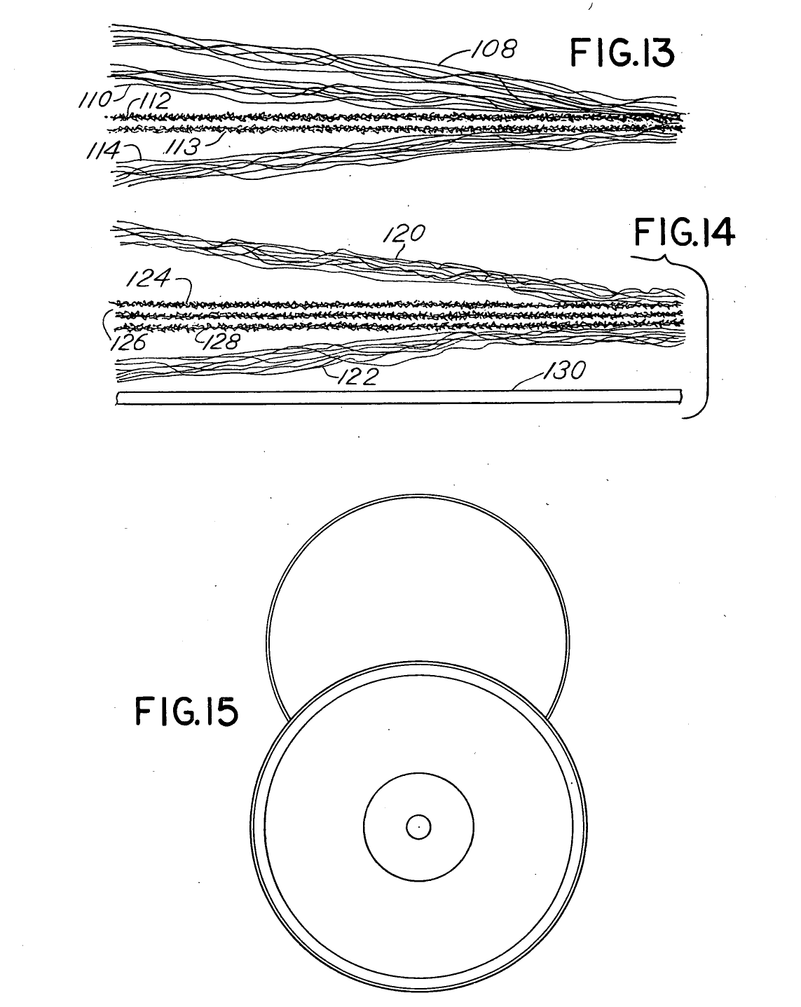

FIG. 13 illustrates a five layer composite (S-S-M-M-S) including an outer layer of 108 of spunbond, a next adjacent layer 110 of spunbond material which in turn or adjacent to melt blown layers 112 and 113 and subsequently another outer spunbond layer 114. The layers are bonded together to form a multilayer fabric.

FIG. 14 illustrates yet another composite material comprised of five layers (S-M-M-M-S) wherein outer layers 120 and 122 are spunbond and inner layers 124 126 and 128 are melt blown. The layers will typically be bonded together to form a multilayered fabric. One or more of the layers may include antimicrobial fibers.

The variety of combinations set forth is not intended to be exhaustive. It encompasses all of these combinations, and others, as would be practiced.

In addition to fabrics created by fibrous structures and composites, there can be fabrics that utilize a combination of fibrous structures with films. The films can have incorporated antimicrobial properties, or not, depending on the requirements of the resulting material. The films can be impervious to liquids and vapors, or can have micro pores that limit the passage of certain materials, while allowing the passage of others. The films can be extruded onto the nonwoven material and bonded in one step, or the film can be cast and formed initially, and subsequently bonded onto the nonwoven, or the film can be bonded using an adhesive, or the film can be attached to the nonwoven that is already bonded into a fabric. In this latter process, the film may or may not be treated with a corona-type charge to enhance attachment. Various attachment methods need not be described in detail, as the spirit of the invention is intended to cover applications where nonwoven fabrics are connected to films to form a single, unified material that has antimicrobial properties.

FIG. 14 also illustrates the combination of a fabric which is gas or air permeable in combination with a film 130. Thus, the five layer composite S-M-M-M-S (FIG. 14) is combined with a layer 130 of permeable or semipermeable or nonpermeable film material. The film material may be made from a polypropylene or polyethylene material that may further be extruded with antimicrobial additives.

FIG. 15 is a photograph of a section of fabric made in accord with the heretofore described invention. The fabric is thus is manufactured from polypropylene fibers having an antimicrobial agent incorporated therewith in the manner discussed, for example, with respect to FIGS. 1-4.

In the following specific examples, fabrics with compositions similar to Fabric Structure FIG. 9 were processed on a Reicofil 3 nonwoven machine as manufactured by Reifenhauser GmbH, of Troisdorf, Germany. The spunbond layers were all three produced from 25 MRF polypropylene homopolymer manufactured by SABIC Industries of Saudi Arabia. The processing temperatures ranged from 190 degrees centigrade in the feed zones of the extruder up to 250 degrees centigrade in and around the spinneret. Quenching conditions were from 18 degrees centigrade to 22 degrees centigrade. The typical pressures used for drawing the filaments range from 2500 kPa to 3500 kPa. Production line speeds are varied to provide the varying fabric weights.

The meltblown layers were produced from 2000 MFR resin as supplied by Basell. The meltblown was produced utilizing a standard meltblown processing configuration, as would be used by those skilled in the art of producing meltblown materials. The processing temperatures ranged from 180 degrees centigrade in the feed zones of the extruder up to 275 degrees centigrade in and around the meltblown spinneret. The meltblown process air was supplied at a temperature of between 260 and 300 degrees centigrade at a flow rate of from 2000 to 3000 cubic meters per hour. The meltblown forming height was at a distance of from 150 to 250 mm from the spinneret to the forming surface. Bonding was accomplished using a hot oil calender. For example as manufactured by Edward Kuesters Machinenfabrik GmbH of Krefeld, Germany, with a nip force of between 80 to 100 Newtons per mm, and a temperature of from 150 to 160 degrees centigrade for both the upper and lower calendering rolls.

The antimicrobial concentrate is Irgaguard B 1315 and was supplied by Ciba Specialty Chemicals. It is a 15 percent by weight concentrate of Irgaguard 131000 (triclosan) in a PETG carrier. The PETG carrier is used to reduce the volatility above processing temperatures of 250 degrees centigrade. In the following examples, only the outer spunbond layers had incorporated the antimicrobial material into the polymer melt and, subsequently, into the resulting filaments.

Analyses were performed by Nelson Laboratories, 6280 South Redwood Road, Salt Lake City, Utah, 84123, U.S.A.

### Antimicrobial Example 1

The five layered S₁-S2-M₁-M₂- S₃ construction material was at a total basis weight of 38 grams per square meter. The weight of the individual spunbond layers was 10.4 grams per square meter each while the weight of the individual layers of the meltblown was 3.4 grams per square meter each. The antimicrobial material was incorporated into layers S₁ and S₃ at a rate of 1 percent by weight of the 15 percent triclosan concentrate. This resulted in a final triclosan addition of 0.15% in each of the two outer spunbond layers. This provided a total addition of 0.03 grams of triclosan into each square meter of 38 gram per square meter fabric, resulting in a final triclosan addition rate of 0.0821 percent.

Samples of the fabric were then tested for antimicrobial activity using staphylococcus aureus ATCC #6538 with an adaptation of the Kirby-Bauer disk diffusion method for antibiotic susceptibility testing. The test organism was standardized to achieve a cell density equivalent to a 0.5 McFarland standard, or an absorbance of 0.08 to 0.10 measured at 625 nanometers on a spectrophotometer. The test organism was then streaked onto two separate Mueller-Hinton agar (MHAG) test plates. The fabric was cut into six circular samples, each of about 6.35 mm diameter. Three of these samples were placed onto one of the test plates with the S₁ side down and in contact with the staphylococcus aureus. The other three circular samples were placed in the second test plate with the S3 side down in direct contact with the test organism.

The plates were incubated at 30 to 35 degree centigrade for 24+/−2 hours and were then evaluated for antimicrobial properties. These properties would be evident if there were a region around the circular samples of fabric where there was no growth of the test organism. This region is called the zone of inhibition. If such a zone exists, the fabric is said to exhibit antimicrobial properties. The diameter of the complete zone is measured using calibrated calipers sensitive to 0.01 mm. After the 24 hour evaluation, the samples were incubated an additional 24+/−2 hours and were again evaluated for the zone of inhibition.

For the first 24 hour evaluation, the plate with the S₁ side down against the test organism exhibited a zone of inhibition (diameter) of 30.32 mm. This would encompass an area of 722 square mm. The plate with the S3 side down against the test organism exhibited a zone of inhibition of 28.77 mm, or a total area of 650 square mm.

The second 24 hour time point resulted in very similar results, with the zones of inhibition for the S₁ and S3 sides exhibiting zones of inhibition of 30.39 mm and 28.29 mm, respectively. It is apparent that the fabric is effective as an antimicrobial material, and both sides exhibit antimicrobial properties. It is also apparent that there is no additional antimicrobial inhibition exhibited with increased exposure time beyond 24 hours of exposure.

### Antimicrobial Example 2

As in Antimicrobial Example 1, Example 2 was prepared in exactly the same manner, with the only difference being the percentage addition of the antimicrobial material to the S₁ and S3 layers. In this example, the concentrate was added at a 3 percent level in both layers. This resulted in an antimicrobial material addition rate of 0.09 grams of triclosan per square meter of 38 gram per square meter fabric, resulting in a triclosan addition rate of 0.2463 percent.

The fabrics were tested in the same manner as the samples in Example 1. At the 24 hour time point, the plate with the S1 side down exhibited a zone of inhibition with a diameter of 30.00 mm, or 707 square mm. The plate with the S3 side against the test organism exhibited a zone of inhibition with a diameter of 29.50 mm, or 683 square mm.

The second 24 hour time point was again similar, as in the Example 1 samples. For the plate with the S1 side down against the staphylococcus aureus, the samples exhibited a zone of inhibition with a diameter of 30.54 mm, or 732 square mm. The plate with the S3 side down against the test organism exhibited a zone of inhibition diameter of 29.74 mm, or 694 square mm. It is again apparent that the fabric is effective as an antimicrobial material, and both sides exhibit antimicrobial properties. It is again also apparent that there is no additional antimicrobial inhibition exhibited with increased exposure time beyond 24 hours of exposure.

### Antimicrobial Example 3

An untreated sample of 38 gram per square mater fabric was produced with the same construction as Examples 1 and 2. Samples of this fabric were cut and prepared using the same methodologies as in Examples 1 and 2. For both test plates, where the S₁ and S₃ sides were down against the test organism, there were no zones exhibited in either the first or the second 24 hour time points. This would be a clear indication that the untreated 38 gram per square meter samples do not exhibit antimicrobial properties and would not be effective as antimicrobial materials.

### Antimicrobial Example 4

The next two examples utilized a five layered S₁-S₂-M₁-M₂-S₃ construction material with a total basis weight of 50 grams per square meter. The weight of the individual spunbond layers was 13.67 grams per square meter each while the weight of the individual layers of the meltblown was 4.50 grams per square meter each. The antimicrobial material was incorporated into layers S₁ and S₃ at a rate of 1 percent by weight of the 15 percent triclosan concentrate. This resulted in a final triclosan addition of 0.15% in each of the two outer spunbond layers. This provided a total addition of 0.041 grams of triclosan into each square meter of 50 gram per square meter fabric, resulting in a final triclosan addition rate of 0.0820 percent.

Samples of the fabric were again tested for antimicrobial activity using staphylococcus aureus ATCC #6538 with an adaptation of the Kirby-Bauer disk diffusion method for antibiotic susceptibility testing. The test organism was again standardized to achieve a cell density equivalent to a 0.5 McFarland standard, or an absorbance of 0.08 to 0.10 measured at 625 nanometers on a spectrophotometer. The test organism was prepared the same way by streaking onto two separate Mueller-Hinton agar (MHAG) test plates. The fabric was cut into six circular samples, each of about 6.35 mm diameter. Three of these samples were placed onto one of the test plates with the S₁ side down and in contact with the staphylococcus aureus. The other three circular samples were placed in the second test plate with the S3 side down in direct contact with the test organism.

The plates were incubated at 30 to 35 degree centigrade for 24+/−2 hours and were then evaluated for antimicrobial properties

For the first 24 hour evaluation, the plate with the S₁ side down against the test organism exhibited a zone of inhibition (diameter) of 24.59 mm, or an area of 475 square mm. The plate with the S3 side down against the test organism exhibited a zone of inhibition of 24.16 mm, or a total area of 458 square mm.

The second 24 hour time point resulted in very similar results, with the zones of inhibition for the S₁ and S₃ sides exhibiting zones of inhibition of 23.98 mm (452 square mm) and 23.32 mm (427 square mm), respectively. It is apparent that the fabric also is effective as an antimicrobial material, and both sides exhibit antimicrobial properties. It is also apparent that there is no additional antimicrobial inhibition exhibited with increased exposure time beyond 24 hours of exposure.

### Antimicrobial Example 5

As in Antimicrobial Example 4, Example 5 was prepared in exactly the same manner, with the only difference being the percentage addition of the antimicrobial material to the S₁ and S₃ layers. In this example, the concentrate was added at a 3 percent level in both layers. This resulted in an antimicrobial material addition rate of 0.123 grams of triclosan per square meter of 50 gram per square meter fabric, resulting in a triclosan addition rate of 0.2463 percent.

The fabrics were tested in the same manner as the samples in Example 4. At the 24 hour time point, the plate with the S₁ side down exhibited a zone of inhibition with a diameter of 29.71 mm, or 693 square mm. The plate with the S3 side against the test organism exhibited a zone of inhibition with a diameter of 29.69 mm, or 692 square mm.

The second 24 hour time point was again similar, as in the Example 3 samples. For the plate with the S₁ side down against the staphylococcus aureus, the samples exhibited a zone of inhibition with a diameter of 29.06 mm, or 663 square mm. The plate with the S3 side down against the test organism exhibited a zone of inhibition diameter of 29.00 mm, or 661 square mm. It is again apparent that the fabric is effective as an antimicrobial material, and both sides exhibit antimicrobial properties. It is again also apparent that there is no additional antimicrobial inhibition exhibited with increased exposure time beyond 24 hours of exposure.

### Antimicrobial Example 6

An untreated sample of 50 gram per square mater fabric was produced with the same construction as Examples 4 and 5. Samples of this fabric were cut and prepared using the same methodologies as in Examples 4 and 5. For both test plates, where the S₁ and S₃ sides were down against the test organism, there were no zones exhibited in either the first or the second 24 hour time points. This would be a clear indication that the untreated 50 gram per square meter samples do not exhibit antimicrobial properties and would not be effective as antimicrobial materials.

Nelson Labs provided two control samples as a part of the testing protocol. These are identified as Examples 7 and 8, where Example 7 was identified as “Positive Control” and Example 8 was identified as “Negative Control”.

### Antimicrobial Example 7

The Positive Control material was a known antimicrobial agent and was prepared and tested in the same manner as the other fabric samples. The Positive Control samples were placed into two separate MHAG test plates, and an evaluation of antimicrobial inhibition was performed at the two 24 hour time points. At the first 24 hour time point, the two Positive Control samples exhibited zones of inhibition of 24.56 and 25.79 mm each. These represented areas of 474 square mm and 522 square mm, respectively. At the second 24 hour time point, the two Positive Control samples exhibited zones of inhibition of 25.68 and 26.10 each. These represented areas of 518 square mm and 535 square mm, respectively. It is clear that the Positive Control samples as provided by Nelson Labs do indeed exhibit antimicrobial properties and would be effect as antimicrobial materials.

### Antimicrobial Example 8

The Negative Control material was known to have no antimicrobial properties. Samples of this material were prepared in the same manner as all others in this study. Circular specimens were cut and placed into two separate MHAG test plates, with evaluations of antimicrobial activity performed at two consecutive 24 hour time points. The Negative Control samples did not exhibit antimicrobial properties at either of the 24 hour time points, confirming that this material would not be effective in an antimicrobial application.

Additional analyses of the fabrics identified herein were performed by Clinical Research Laboratories, Inc., 371 Hoes Lane, Piscataway, N.J. 08854, U.S.A. to determine the dermal irritation potential of the fabric following a single application. The test fabrics were cut into squares to fit the webril portion of a patch. The patch was then applied to the upper back of each subject between the scapulae and the waist and allowed to remain in direct skin contact for a period of 48 hours. At the end of the 48 hour period the patches were removed and the sites graded for dermal irritation. Under the conditions of the study, the test fabrics did not demonstrate a potential for eliciting dermal irritation.

Other analyses of the fabrics included an in vitro elution test for oytotoxicity. This test was performed by the Department of Experimental Biology, Huntingdon Life Sciences Limited, Woolley Road, Alconbury, Huntingdon, Cambridgeshire PE28 4HS, England. The test included sub-confluent monolayers of MRC-5 cells (human embryonic lung fibroblasts) grown in 96-well plates that were exposed for 24±0.5 hours to eluates of the test and control samples. Eluates were prepared by incubation of samples and controls at 37±1° C. on an orbital shaker for 24±0.5 hours, in Basal Medium Eagle's (BME) containing antibiotics and 10%(v/v) foetal calf serum. The test sample was supplied unsterile and eluted at a ration of 0.2 g/ml. The negative control was eluted at a ratio of 0.2 g/ml and the positive control eluted at 0.08 g/ml of medium. The test sample eluate was passed through a 0.45 pm filter before dilution and testing. The sample and positive control eluates were serially diluted, in 2-fold steps. The negative control was tested undiluted. Four cell cultures were exposed to each dilution of sample, or control eluate. Cytotoxity of stained cultures was assessed by microscopy and it was determined that the cytotoxic titer was non-toxic.

Yet another test performed on the fabrics described herein was performed by NAMSA, 9 Morgan, Irvine Calif. 92618 to determine antimicrobial activity of immobilized antimicrobial agents, per ASTM E2149-01. A sample fabric was tested as having a starting organism count of 1.40×10⁵ (CFU/ml) and a control had a starting organism count of 1.32×10⁵ (CFU/ml). After 0.5 hours, the sample fabric had an organism count of 1.59×10⁵ (CFU/ml) and the control had an organism count of 1.83×10⁵ (CFU/ml). After 1 hour, the sample fabric had an organism count of 2.00×10⁵ (CFU/ml) and the control had an organism count of 2.11×10⁵ (CFU/ml). After 1.5 hours, the sample fabric had an organism count of 1.60×10⁵ (CFU/ml) and the control had an organism count of 2.12×10⁵ (CFU/ml). After 2 hours, the fabric sample had an organism count of 1.58×10⁵ (CFU/ml) and the control had an organism count of 1.83×10⁵ (CFU/ml). After 4 hours, the fabric sample had an organism count of 1.68×10⁵ (CFU/ml) and the control had an organism count of 1.95×10⁵ (CFU/ml).

As mentioned previously, the antimicrobial material can be incorporated into any or all layers of a multi-layered fabric. The preferred examples listed previously demonstrate materials that contain antimicrobial materials in the outer layers of the various fabrics. It should be understood that the aforementioned text relates only to preferred embodiments of the present invention and that numerous modifications or alterations may be made therein without departing from the spirit and the scope of the invention as identified and set forth in the appended claims.

What is claimed is:

1. An antimicrobial, gas permeable fabric comprising, in combination:
an non-woven array of extruded polymeric fibers comprised of at least one melt extrudable polymer mixed with an antimicrobial agent dispersed generally uniformly in the fiber.

2. The fabric of claim 1 wherein the fibers are at least in part spun bond.

3. The fabric of claim 1 wherein the fibers are at least in part melt blown.

4. The fabric of claim 1 wherein the fabric is comprised of a mixture of layers of non-woven spun bond and melt blown materials.

5. The fabric of claim 1 wherein the fabric is comprised of an array of layers of non-woven spun bond and melt blown fibers said array selected from the group consisting of: S-S; S-S-S; M-M; M-M-M; S-M-S; S-M-M-S; S-M-M-M-S; and S-S-M-M-S wherein S is a spun bond layer and M is a melt blown layer

6. The fabric of claim 1 wherein the polymer is one or more thermoplastic polyolefins selected from the group consisting of polyethylene; polypropylene; poly (1-butene); poly (2-butene); poly (1-pentene); poly (2-pentene); poly (3-methyl-1-pentene); poly (4-methyl-pentene); 1,2-poly-1,3-butadiene; 1,4-poly-1,3-butadiene; polyisoprene; polychloroprene; poly (vinyl acetate); poly (vinylidene chloride) and polystyrene.

7. The fabric of claim 1 wherein the antimicrobial material comprises about 0.1 to 25 weight % of the fabric.

8. The fabric of claim 1 wherein the fiber has a mean diameter in the range of 16.7 to 18.0 microns.

9. The fabric of claim 1 wherein the fabric further includes a filmic layer.

10. The fabric of claim 1 wherein the fibers are formulated by premixing a polymeric and antimicrobial agent and subsequent melt processing and extrusion of the fibers.

11. The fabric of claim 10 wherein the melt processing is conducted in an extruder.

12. The fabric of claim 1 wherein the polymer is selected from the group consisting of thermosetting polymers, thermoplastic polymers and mixtures thereof.

13. The fabric of claim 1 wherein the fibers are at least in part non-woven and thermally bonded at least in part.

14. The fabric of claim 1 wherein the antimicrobial material comprises about 0.1 to 10% by weight.

15. The fabric of claim 1 wherein the antimicrobial material comprises about 0.1 to 1.0% by weight.

16. A method for manufacture of a gas permeable, antimicrobial non-woven fabric comprising the steps of:
(a) forming a polymeric melt from a melt-extrudable material;
(b) mixing an antimicrobial agent in the melt;
(c) extruding the resultant mix to form a solid phase fiber;
(d) consolidating multiple fibers to form a non-woven fabric layer.

17. The method of claim 16 wherein extruded fibers are spunbond.

18. The method of claim 16 wherein the extruded fibers are melt blown.

19. The method of claim 18 wherein consolidating includes incorporating layers of spunbond fibers with melt blown fibers.
